(19) United States
(12) Patent Application Publication
(10) Pub. No.: US 2023/0097451 A1
(43) Pub. Date: Mar. 30, 2023

(54) DISPLAY PANEL, TOUCH DISPLAY DEVICE, AND A METHOD FOR MANUFACTURING A TOUCH DISPLAY DEVICE

(71) Applicant: HUIZHOU CHINA STAR OPTOELECTRONICS TECHNOLOGY CO., LTD., Huizhou, Guangdong (CN)

(72) Inventors: Dongchen HUANG, Huizhou, Guangdong (CN); Chingyuan CHENG, Huizhou, Guangdong (CN); Hongji LI, Huizhou, Guangdong (CN); Yuexia LIN, Huizhou, Guangdong (CN)

(21) Appl. No.: 17/041,144

(22) PCT Filed: Aug. 3, 2020
(86) PCT No.: PCT/CN2020/106593

§ 371 Date: Sep. 24, 2020

(30) Foreign Application Priority Data
Jun. 12, 2020 (CN) 202010537939.7

(51) Int. Cl. G06F 3/041; G06F 3/042; G02F 1/1339; G02F 1/1335; G02F 1/1333

(52) U.S. Cl. CPC G06F 3/0412; G06F 3/0421; G02F 1/1339; G02F 1/133553; G02F 1/13338; G06F 2203/04102; G06F 2203/04103

(57) ABSTRACT

A display panel, a touch display device, and a method for manufacturing a touch display device are provided in the present disclosure. The display panel includes a display area and a non-display area adjacent to the display area. The display panel includes a first substrate and a second substrate disposed opposite to each other; a first narrow border sealant located in the non-display area, and a liquid crystal layer located in the display area disposed between the first substrate and the second substrate; and a first reflective layer disposed on at least one side of the first narrow border sealant.

### FIELD OF INVENTION

The present disclosure relates to the field of display technologies, and more particularly, to a display panel, a touch display device, and a method for manufacturing a touch display device.

### BACKGROUND OF INVENTION

With the development of display technology, touch displays with narrow borders and large sizes have become the focus of this industry. The existing touch screen is composed of a display panel and a touch panel.

### Technical Problems

Currently, in a box structure, such as a display panel, encapsulated by the upper and lower substrates combined with a sealant, the sealant is cured by irradiation in a direction from a side of the display panel to the sealant. However, limited by the factors of the irradiation intensity and the low reflectivity of structures of black retaining walls located on an upper side and a lower side of the sealant in the display panel, the curing rate of the sealant and the curing depth of the sealant are insufficient. Therefore, a greater width of the sealant is required to ensure the adhering of the upper and lower substrates to form a box structure. That is, the border width of the box structure, such as the display panel, is increased, and then the border width of the touch screen is also affected.

### SUMMARY OF INVENTION

### Technical Solutions

The present disclosure provides a display panel, a touch display device, and a method for manufacturing a touch display device, to solve the technical problems that in a box structure of the existing display panel encapsulated by a sealant, in a process of curing the sealant by lateral irradiation, limited by the factors of the irradiation intensity and the low reflectivity of structures of black retaining walls located on an upper side and a lower side of the sealant in the display panel, the curing rate of the sealant and the curing depth of the sealant are insufficient, so that a greater width of the sealant is required, and a border width of the box structure, such as the display panel, is increased.

In order to solve the above problems, the technical solutions provided by this disclosure are as follows:

The present disclosure provides a display panel, including a display area and a non-display area adjacent to the display area, the display panel including: a first substrate and a second substrate disposed opposite to each other; a first narrow border sealant located in the non-display area, and a liquid crystal layer located in the display area disposed between the first substrate and the second substrate; and a first reflective layer disposed on at least one side of the first narrow border sealant.

In the display panel provided by the present disclosure, the first reflective layer includes a first reflective pattern, and an area of a side of the first reflective pattern away from the display area is greater than an area of a side of the first reflective pattern close to the display area.

In the display panel provided by the present disclosure, the first reflective pattern includes a plurality of first reflectors, and the plurality of first reflectors are disposed around the display area and arranged as at least one circle; wherein,

when the first reflective pattern includes the plurality of first reflectors arranged as one circle, an area of a side portion of the first reflector away from the display area is greater than an area of another side portion of the first reflector close to the display area;

when the first reflective pattern includes the plurality first reflectors arranged as at least two circles, in the adjacent two circles of the plurality of first reflectors , an area of the first reflector in the circle away from the display area is greater than an area of the first reflector in the other circle close to the display area.

In the display panel provided by the present disclosure, the first reflective pattern includes the plurality of first reflectors arranged as at least two circles, in the adjacent two circles of the plurality of first reflectors, an arrangement density of the plurality of first reflectors in the circle away from the display area is greater than an arrangement density of the plurality of first reflectors in the other circle close to the display area.

In the display panel provided by the present disclosure, a first black retaining wall is disposed on a side of the first reflective layer away from the first narrow border sealant.

The present disclosure further provides a touch display device, including: a touch panel, and a display panel as mentioned above; a second narrow border sealant located in the non-display area disposed between the display panel and the touch panel; and a second reflective layer disposed on at least one side of the second narrow border sealant.

In the touch display device provided by the present disclosure, the second reflective layer includes a second reflective pattern, and an area of a side of the second reflective pattern away from the display area is greater than an area of a side of the second reflective pattern close to the display area.

In the touch display device provided by the present disclosure, the second reflective pattern includes a plurality of second reflectors, and the plurality of second reflectors are disposed around the display area and arranged as at least one circle; wherein,

when the second reflective pattern includes the plurality of second reflectors arranged as one circle, an area of a side portion of the second reflector away from the display area is greater than an area of another side portion of the second reflector close to the display area;

when the second reflective pattern includes the plurality of second reflectors arranged as at least two circles, in the adjacent two circles of the plurality of second reflectors, an area of second reflector in the circle away from the display area is greater than an area of the second reflector in the other circle close to the display area.

In the touch display device provided by the present disclosure, the second reflective pattern includes the plurality of second reflectors arranged as at least two circles, in the adjacent two circles of the plurality of second reflectors, an arrangement density of the plurality of second reflectors in the circle away from the display area is greater than an arrangement density of the plurality of second reflectors in the other circle close to the display area.

In the touch display device provided by the present disclosure, the touch panel includes: a package cover plate and a touch substrate disposed opposite to each other; a third narrow border sealant located in the non-display area disposed between the package cover plate and the touch substrate; and a third reflective layer disposed on at least one side of the third narrow border sealant.

In the touch display device provided by the present disclosure, the third reflective layer includes a third reflective pattern, and an area of a side of the third reflective pattern away from the display area is greater than an area of a side of the third reflective pattern close to the display area.

In the touch display device provided by the present disclosure, the third reflective pattern includes a plurality of third reflectors, and the plurality of third reflectors are disposed around the display area and arranged as at least one circle; wherein,

when the third reflective pattern includes the plurality of third reflectors arranged as one circle, an area of a side portion of the third reflector away from the display area is greater than an area of another side portion of the third reflector close to the display area;

when the third reflective pattern includes the plurality third reflectors arranged as at least two circles, in the adjacent two circles of the plurality of third reflectors, an area of the third reflector in the circle away from the display area is greater than an area of the third reflector in the other circle close to the display area.

In the touch display device provided by the present disclosure, the third reflective pattern includes the plurality of third reflectors arranged as at least two circles, in the adjacent two circles of the plurality of third reflectors, an arrangement density of the plurality of third reflectors in the circle away from the display area is greater than an arrangement density of the plurality of third reflectors in the other circle close to the display area.

In the touch display device provided by the present disclosure, a second black retaining wall is disposed on a side of the third reflective layer away from the third narrow border sealant.

In the touch display device provided by the present disclosure, the first reflective layer includes a first reflective pattern, and an area of a side of the first reflective pattern away from the display area is greater than an area of a side of the first reflective pattern close to the display area.

In the touch display device provided by the present disclosure, the first reflective pattern includes a plurality of first reflectors, and the plurality of first reflectors are disposed around the display area and arranged as at least one circle; wherein,

when the first reflective pattern includes the plurality of first reflectors arranged as one circle, an area of a side portion of the first reflector away from the display area is greater than an area of another side portion of the first reflector close to the display area;

when the first reflective pattern includes the plurality first reflectors arranged as at least two circles, in the adjacent two circles of the plurality of first reflectors, an area of the first reflector in the circle away from the display area is greater than an area of the first reflector in the other circle close to the display area.

In the touch display device provided by the present disclosure, the first reflective pattern includes the plurality of first reflectors arranged as at least two circles, in the adjacent two circles of the plurality of first reflectors, an arrangement density of the plurality of first reflectors in the circle away from the display area is greater than an arrangement density of the plurality of first reflectors in the other circle close to the display area.

The present disclosure further provides a method for manufacturing a touch display device, including the following steps:

providing a touch panel and a display panel, wherein the display panel includes a display area and a non-display area adjacent to the display area;

forming a second reflective layer in the non-display area on the touch panel and/or the display panel, and forming a second narrow border sealant on the second reflective layer between the touch panel and the display panel; and

aligning and adhering the touch panel with the display panel, and curing the second narrow border sealant by lateral irradiation.

In the method for manufacturing a touch display device provided by the present disclosure, the step of providing the display panel includes:

providing a first substrate and a second substrate;

forming a first reflective layer in the non-display area on the first substrate and/or the second substrate, and forming a first narrow border sealant on the first reflective layer between the first substrate and the second substrate; and

aligning and adhering the first substrate with the second substrate, and curing the first narrow border sealant by lateral irradiation.

In the method for manufacturing a touch display device provided by the present disclosure, the step of providing the touch panel includes:

providing a package cover plate and a touch substrate;

forming a third reflective layer in the non-display area on the package cover plate and/or the touch substrate, and forming a third narrow border sealant on the third reflective layer between the package cover plate and the touch substrate; and

aligning and adhering the package cover plate with the touch substrate, and curing the third narrow border sealant by lateral irradiation.

### Beneficial Effect

The beneficial effect of the present disclosure is that: in the present disclosure, the first reflective layer is disposed on at least one side of the first narrow border sealant, so that when the first narrow border sealant is being cured by irradiation, the light penetration depth is enhanced by the first reflective layer reflecting light. Therefore, the curing depth of the first narrow border sealant is increased and the curing rate of the first narrow border sealant is increased, which facilitates forming the box structure of the display panel by using a first narrow border sealant with a short width. The box structure, such as the display panel with a narrow border is realized. In the touch display device of the present disclosure, the touch display device with a narrow border is realized by disposing the second reflective layer on at least one side of the second narrow border sealant located between the display panel and the touch panel. In addition, the method for manufacturing this structure is well-developed and simple, and the curing rate of the sealant in the method is efficient, it which facilitates manufacturing the touch display device with the narrow border.

### DESCRIPTION OF DRAWINGS

In order to more clearly illustrate the technical solutions in the embodiments or the prior art, the following drawings, which are intended to be used in the description of the embodiments or the prior art, will be briefly described. It is obvious that the drawings and the following description are only some embodiments of the present disclosure. Those of ordinary skill in the art may, without creative efforts, derive other drawings from these drawings.

FIG. 1 is a schematic structural diagram of a display panel according to one embodiment of the present disclosure.

FIG. 2 is a first cross-sectional schematic structural diagram in the direction A-A in FIG. 1.

FIG. 3 is a second cross-sectional schematic structural diagram in the direction A-A in FIG. 1.

FIG. 4 is a third cross-sectional schematic structural diagram in the direction A-A in FIG. 1.

FIG. 5 is a first schematic structural diagram of a touch display device according to one embodiment of the present disclosure.

FIG. 6 is a first cross-section schematic structural diagram in the direction B-B in FIG. 5.

FIG. 7 is a second cross-section schematic structural diagram in the direction B-B in FIG. 5.

FIG. 8 is a third cross-section schematic structural diagram in the direction B-B in FIG. 5.

FIG. 9 is a first cross-section schematic structural diagram in the direction C-C in FIG. 5.

FIG. 10 is a second cross-section schematic structural diagram in the direction C-C in FIG. 5.

FIG. 11 is a third cross-section schematic structural diagram in the direction C-C in FIG. 5.

FIG. 12 is a second schematic structural diagram of a touch display device according to one embodiment of the present disclosure.

FIG. 13 is a schematic flow chart of a first method for manufacturing a touch display device according to one embodiment of the present disclosure.

FIG. 14 is a schematic flow chart of a second method for manufacturing a touch display device according to one embodiment of the present disclosure.

FIG. 15 is a schematic flow chart of a third method for manufacturing a touch display device according to one embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the figure(s) being described. As such, the directional terminology is used for purposes of illustration and is in no way limiting. Throughout this specification and in the drawings like parts will be referred to by the same reference numerals.

In the description of the present disclosure, it is to be understood that orientation or positional relationships of the terms of “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, etc. are based on orientation or positional relationships shown by the figures. It is merely for the convenience of describing the present disclosure and simplifying the description, but not indicating or implying, to which a device or a component is referred, must have a specific orientation, or must be constructed and operated in a specific orientation. Therefore, it should not be construed as limiting the disclosure. Moreover, the terms “first” and “second” are merely used for descriptive purposes and are not to be construed as indicating or implying a relative importance, or as implicitly indicating the number of the indicated technical features. Thus, features defining “first” or “second” may include one or more of the described features either explicitly or implicitly. In the description of the present disclosure, the meaning of “a plurality” is two or more unless otherwise specifically defined.

In the description of the present disclosure, it should be noted that the terms of “mount”, “connect with each other”, and “connect” are to be understood broadly. For example, it can be a fixed connection, a detachable connection, or an integral connection. It can be a mechanical connection, or it can be electrically connected or can be communicated with each other. It can be directly connected, or can be indirectly connected through an intermediate medium. It can mean two components connected to each other internally, or an interacting relationship between two components. The specific meanings of the above terms in the present disclosure can be understood by those skilled in the art in specific conditions.

In the present disclosure, a first feature “on” or “under” a second feature can include direct contact of the first and second features, and can also include that the first and second features are not in direct contact but are contacted by additional features between them. Moreover, the meaning of the first feature being “on”, “above” and “upside” the second feature includes the first feature directly above and obliquely above the second feature, or merely indicates that a horizontal height of the first feature is higher than a horizontal height of the second feature. The meaning of the first feature being “lower”, “below” and “downside” the second feature includes the first feature directly lower and below the second feature, or merely indicates that a horizontal height of the first feature is less than a horizontal height of the second feature.

The following publication provides many different embodiments or examples for implementing different structures of the present disclosure. In order to simplify the publication of the present disclosure, the components and arrangements of the specific examples are described below. Of course, they are merely examples and are not intended to limit the disclosure. In addition, the present disclosure may be repeated with reference to the numerals and/or reference numerals in the various examples, which are for the purpose of simplicity and clarity, and do not indicate the relationship between the various embodiments and/or arrangements discussed. Moreover, the present disclosure provides examples of various specific processes and materials, but one of ordinary skilled in the art will recognize the use of other processes and/or the use of other materials.

The technical solution of the present disclosure will now be described in conjunction with specific embodiments.

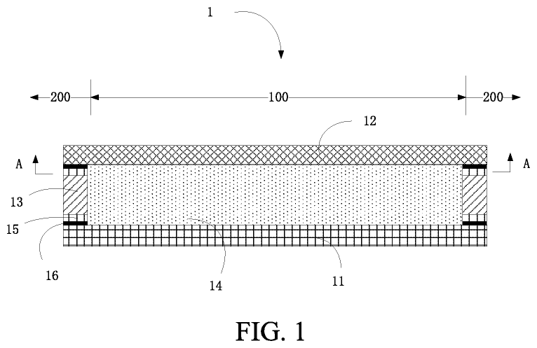

The present disclosure provides a display panel 1, as shown in FIG. 1 to FIG. 4, including a display area 100 and a non-display area 200 adjacent to the display area 100. The display panel includes a first substrate 11 and a second substrate 12 disposed opposite to each other. A first narrow border sealant 13 located in the non-display area 200, and a liquid crystal layer 14 located in the display area 100 are disposed between the first substrate 11 and the second substrate 12. A first reflective layer 15 are disposed on at least one side of the first narrow border sealant 13.

It can be understood that, with the development of display technology, in a box structure, such as a display panel, encapsulated by combining the upper and lower substrates with a sealant, the sealant is cured by irradiation from a side which the display panel located. However, limited by the factors of the irradiation intensity and the low reflectivity of structures of black retaining walls located on an upper side and a lower side of the sealant in the display panel, so that a greater width of the sealant is required to ensure the adhering of the upper and lower substrates to form a box structure. That means the border width of the box structure, such as the display panel, is increased. In the present embodiment, the first reflective layer 15 is disposed on at least one side of the first narrow border sealant 13, so that when the first narrow border sealant 13 is being cured by irradiation, the light penetration depth is enhanced by the first reflective layer 15 reflecting light. Therefore, the curing depth of the first narrow border sealant 13 is increased and the curing rate of the first narrow border sealant 13 is increased, which facilitates forming the box structure of the display panel 1 by using the first narrow border sealant 13 with a short width. The box structure, such as the display panel 1, with a narrow border, is realized.

As mentioned above, in the present embodiment, as shown in FIG. 1, the first reflective layers 15 are disposed on both side of the first narrow border sealant 13. Obviously, the first reflective layers 15 are disposed on both sides of the first narrow border sealant 13, such that the light is reflected multiple times between the upper and lower first reflective layers 15 during the process of curing the first narrow border sealant 13 by lateral irradiation with an ultraviolet light source. In this way, the optical path of the light within the first narrow border sealant 13 is increased, the curing depth of the first narrow border sealant 13 is increased, and the saturation of the light per unit area of the first narrow border sealant 13 is also increased, therefore the curing rate of the first narrow border sealant 13 is increased. Wherein, the first reflective layer 15 may be various reflective materials such as metal. Specifically, the material of the first reflective layer 15 includes metal materials such as copper, aluminum, molybdenum, etc. Obviously, when the material of the first reflective layer 15 is aluminum, the reflectivity of the first reflective layer 15 can reach 90% in the wavelength band of light between 300 nm to 400 nm.

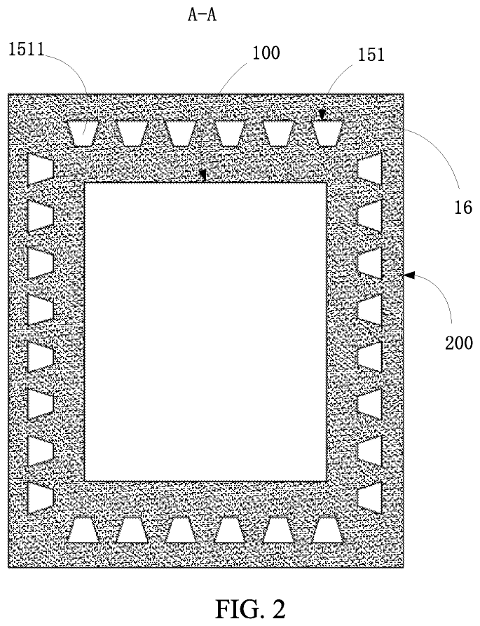

In one embodiment, as shown in FIG. 2 to FIG. 4, the first reflective layer 15 includes a first reflective pattern 151, and an area of a side of the first reflective pattern 151 away from the display area 100 is greater than an area of a side of the first reflective pattern 151 close to the display area 100. It should be understood that the first reflective layer 15 may be patterned to form the first reflective pattern 151, and the reflection of the light in a specific area and the fine control of the reflection amount are realized by the first reflective pattern 151. In addition, the first reflective pattern 151 prevent that the first narrow border sealant 13 only adheres with the first reflective layer 15 once the first reflective layer 15 is disposed on the entire surface. Therefore, the first narrow border sealant 13 is not only adhered with the first reflective layer 15 but also adhered with the first substrate 11 or the second substrate 12 through the hollow positions of the first reflective layer 15. In this way, the box structure by the first substrate 11 and the second substrate 12 is more secure. Furthermore, the area of the side of the first reflective pattern 151 away from the display area 100 is greater than the area of the side of the first reflective pattern 151 close to the display area 100, which results the side of the first reflective pattern 151 away from the display area 100 has a batter light reflecting ability than the side of the first reflective pattern 151 close to the display area 100. That facilitates the light which just entered the first narrow border sealant 13 with a stronger light intensity be reflected in more times. In addition, it should be understood that the side of the first reflective pattern 151 close to the display area 100 (that is, the side of the first reflective pattern 151 away from the ultraviolet light source) obviously receives the light with a weaker light intensity. The area of the first reflective pattern 151 can be relatively reduced in here to generate a greater hollow position which facilitate the first narrow border sealant 13 adhering with the first substrate 11 or the second substrate 12.

In one embodiment, as shown in FIG. 2 to FIG. 4, the first reflective pattern 151 includes a plurality of first reflectors 1511, and the plurality of first reflectors 1511 are disposed around the display area 100 and arranged as at least one circle; wherein,

when the first reflective pattern 151 includes the plurality of first reflectors 1511 arranged as one circle, an area of a side portion of the first reflector 1511 away from the display area 100 is greater than an area of another side portion of the first reflector 1511 close to the display area 100;

when the first reflective pattern 151 includes the plurality first reflectors 1511 arranged as at least two circles, in the adjacent two circles of the plurality of first reflectors 1511, an area of the first reflector 1511 in the circle away from the display area 100 is greater than an area of the first reflector 1511 in the other circle close to the display area 100.

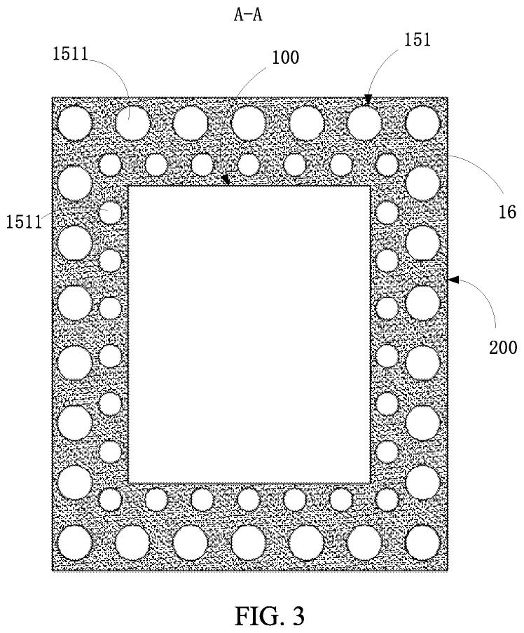

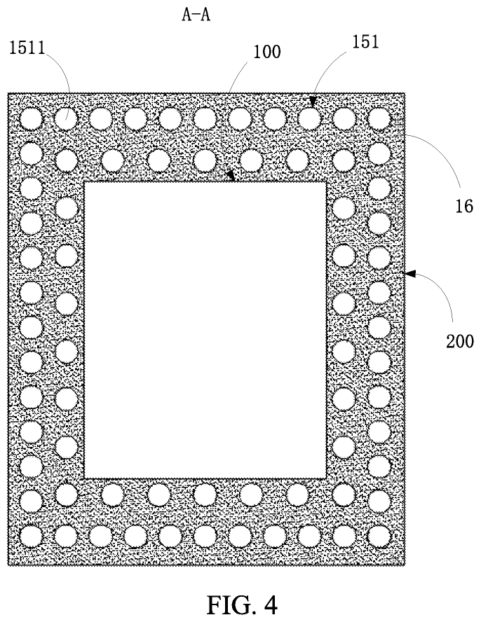

It should be understood that the shape of the first reflector 1511 may be regular or irregular, and which may be an ellipse, a trapezoid, a triangle, a circle or a rectangle, etc. Specifically, as shown in FIG. 2, when the first reflective pattern 151 includes the plurality of first reflectors 1511 arranged as one circle, the first reflector 1511 may be a triangle or a trapezoid, such that the area of a side portion of the first reflector 1511 away from the display area 100 is greater than the area of another side portion of the first reflector 1511 close to the display area 100. For example, when the shape of the first reflector 1511 is a trapezoid, the short side portion of the first reflector 1511 is located in the side close to the display area 100, and the long side portion of the first reflector 1511 is located in the side away from the display area 100, such that the area of a side portion of the first reflector 1511 away from the display area 100 is greater than the area of another side portion of the first reflector 1511 close to the display area 100. As shown in FIG. 3, when the first reflective pattern 151 includes the plurality first reflectors 1511 arranged as at least two circles, in the adjacent two circles of the plurality of first reflector 1511, the area of each the first reflector 1511 in the circle away from the display area 100 is greater than the area of each the first reflector 1511 in the other circle close to the display area 100. As shown in FIG. 4, in the adjacent two circles of the plurality of first reflectors 1511, the area of the first reflector 1511 in the circle away from the display area 100 is greater than the area of the first reflector 1511 in the other circle close to the display area 100 can be realized by ensuring that an arrangement density of the plurality of first reflectors 1511 in the circle away from the display area 100 is greater than an arrangement density of the plurality of first reflectors 1511 in the other circle close to the display area 100.

In one embodiment, as shown in FIG. 1, a first black retaining wall 116 is disposed on a side of the first reflective layer 15 away from the first narrow border sealant 13. It should be understood that in the display panel 1, structures such as the first black retaining wall 16 and the like have almost zero reflectance to light, which are very easy to absorb light, so that the light intensity of the light curing the first narrow border sealant 13 is reduced. In the present embodiment, the first reflective layer 15 is disposed between the first black retaining wall 16 and the first narrow border sealant 13, which reduces the absorption of light by the first black retaining wall 16. In the present embodiment, the first reflective layer 15 is only disposed on a side of the first narrow border sealant 13. Specifically, the first reflective layer 15 is disposed on the side of the first narrow border sealant 13 close to the first black retaining wall 16.

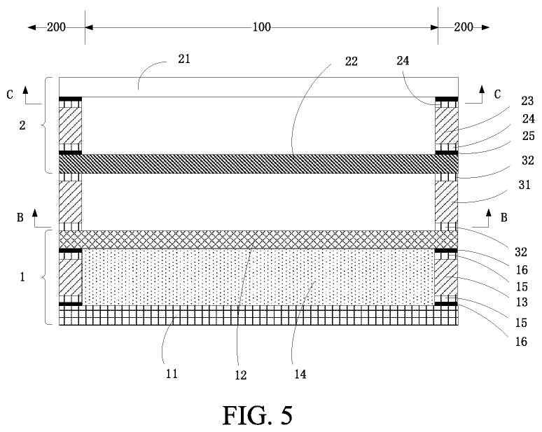

In the touch display device provided by the present disclosure, as shown in FIG. 5, the touch display device includes a touch panel 2, and a display panel 1 as mentioned above. A second narrow border sealant 31 located in the non-display area 200 is disposed between the display panel 1 and the touch panel 2. A second reflective layer is disposed on at least one side of the second narrow border sealant 31.

It should be understood that, currently, in the touch display device, the display panel and the touch panel are aligned and adhered with each other by an edge lamination technology . A sealant is coated between the display panel and the touch panel, and then the sealant is cured to form a box structure. However, the portion of the display panel and the portion of the touch panel close to the sealant are transparent or translucent structures such as glass substrates, those structures have low reflectivity for the light used to cure the sealant during the process of curing the sealant. The above factors results that the curing rate of the sealant and the curing depth of the sealant are insufficient, such that a greater width of the sealant is required to increase the adhering area, and then the border width of the touch screen is increased. In the present embodiment, the second reflective layer 32 is disposed on at least one side of the second narrow border sealant 31, so that when the second narrow border sealant 32 is being cured by irradiation, the light penetration depth is enhanced by the second reflective layer 32 reflecting light. Therefore, the curing depth of the second narrow border sealant 31 is increased and the curing rate of the second narrow border sealant 31 is increased, which facilitates forming the box structure of the touch display device by using the second narrow border sealant 31 with a short width. The touch display device with a narrow border is realized.

As mentioned above, in the present embodiment, as shown in FIG. 5, the second reflective layers 32 are disposed on both sides of the second narrow border sealant 31. Obviously, the second reflective layers 32 are disposed on both sides of the second narrow border sealant 31, such that the light is reflected multiple times between the upper and lower second reflective layers 32 during the process of curing the second narrow border sealant 31 by lateral irradiation with an ultraviolet light source. In this way, the optical path of the light within the second narrow border sealant 31 is increased, the curing depth of the second narrow border sealant 31 is increased, and the saturation of the light per unit area of the second narrow border sealant 31 is also increased, therefore the curing rate of the second narrow border sealant 31 is increased. The material of the second reflective layer 32 may be the same as the material of the first reflective layer 15 and which will not be repeated here.

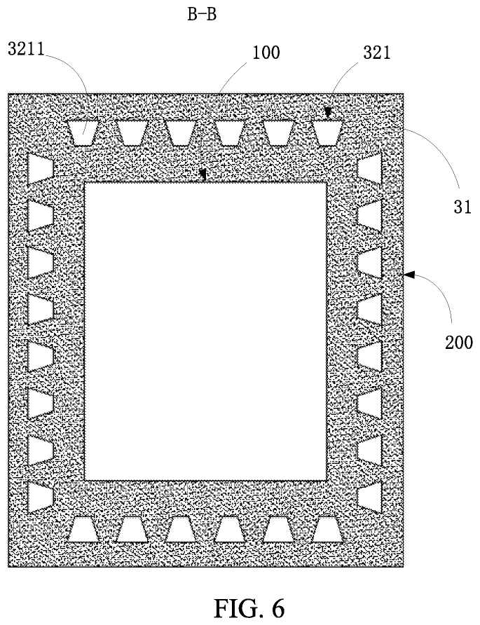

In one embodiment, as shown in FIG. 6 to FIG. 8, the second reflective layer 32 includes a second reflective pattern 321, and an area of a side of the second reflective pattern 321 away from the display area 100 is greater than an area of a side of the second reflective pattern 321 close to the display area 100. It should be understood that, the second reflective layer 32 may be patterned to form the second reflective pattern 321, and the effect produced by the second reflective pattern 321 is similar the first reflective pattern 151. In this way, the area of the side of the second reflective pattern 321 away from the display area 100 is greater than the area of the side of the second reflective pattern 321 close to the display area 100, which results the side of the second reflective pattern 321 away from the display area 100 has a batter light reflecting ability than the side of the second reflective pattern 321 close to the display area 100. That facilitates the light which just entered the second narrow border sealant 31 with a stronger light intensity be reflected in more times. In addition, the side of the second reflective pattern 321 close to the display area 100 has a less reflective area, and a greater hollow position is generated. That facilitates the second narrow border sealant 31 adhering with the first substrate 11 or the second substrate 12.

In one embodiment, as shown in FIG. 6 to FIG. 8, the second reflective pattern 321 includes a plurality of second reflectors 3211, and the plurality of second reflectors 3211 are disposed around the display area 100 and arranged as at least one circle; wherein,

when the second reflective pattern 321 includes the plurality of second reflectors 3211 arranged as one circle, an area of a side portion of the second reflector 3211 away from the display area 100 is greater than an area of another side portion of the second reflector 3211 close to the display area 100;

when the second reflective pattern 321 includes the plurality of second reflectors 3211 arranged as at least two circles, in the adjacent two circles of the plurality of second reflectors 3211, an area of second reflector 3211 in the circle away from the display area 100 is greater than an area of the second reflector 3211 in the other circle close to the display area 100.

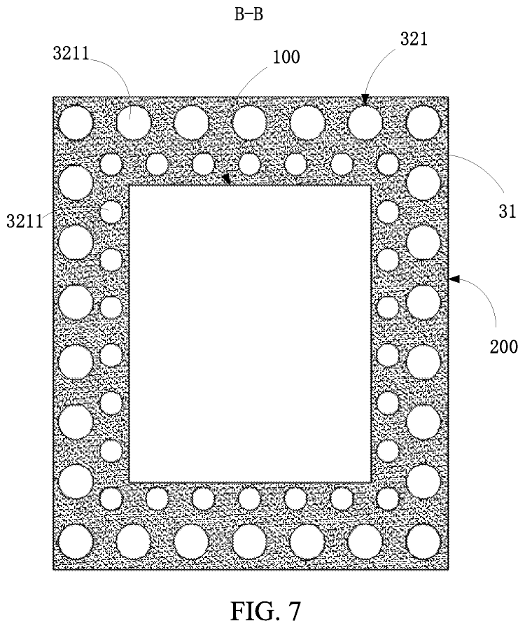

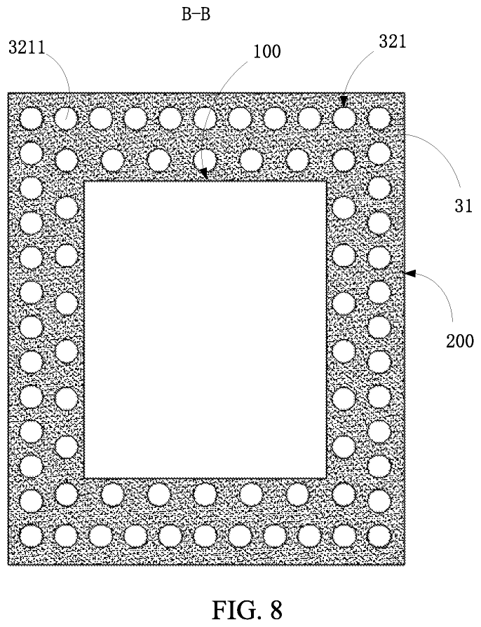

It should be understood that, the second reflector 3211 may have the same shape selection as the first reflector 1511, and which will not be repeated here. Specifically, as shown in FIG. 6, when the second reflective pattern 321 includes the plurality of second reflectors 3211 arranged as one circle, the second reflector 3211 may be a triangle or a trapezoid, such that the area of a side portion of the second reflector 3211 away from the display area 100 is greater than the area of another side portion of the second reflector 3211 close to the display area 100. For example, when the shape of the second reflector 3211 is a trapezoid, the short side portion of the second reflector 3211 is located in the side close to the display area 100, and the long side portion of the second reflector 3211 is located in the side away from the display area 100, such that the area of a side portion of the second reflector 3211 away from the display area 100 is greater than the area of another side portion of the second reflector 3211 close to the display area 100. As shown in FIG. 7, when the second reflective pattern 321 includes the plurality second reflectors 3211 arranged as at least two circles, in the adjacent two circles of the plurality of second reflector 3211, the area of each the second reflector 3211 in the circle away from the display area 100 is greater than the area of each the second reflector 3211 in the other circle close to the display area 100. As shown in FIG. 8, in the adjacent two circles of the plurality of second reflectors 3211, the area of the second reflector 3211 in the circle away from the display area 100 is greater than the area of the second reflector 3211 in the other circle close to the display area 100 can be realized by ensuring that an arrangement density of the plurality of second reflectors 3211 in the circle away from the display area 100 is greater than an arrangement density of the plurality of second reflectors 3211 in the other circle close to the display area 100.

In one embodiment, as shown in FIG. 5, the touch panel 2 includes a package cover plate 21 and a touch substrate 22 disposed opposite to each other. A third narrow border sealant 23 located in the non-display area 200 is disposed between the package cover plate 21 and the touch substrate 22, and a third reflective layer 24 is disposed on at least one side of the third narrow border sealant 23.

It should be understood that, currently, shading structures, such as block retaining walls, are also disposed in the non-display area of the display panel. The block retaining walls have a low reflectivity as mentioned above, the sealant of the touch panel also has those problems, such as the insufficient curing rate and the insufficient curing depth, and which will not be repeated here. In the present embodiment, the third reflective layer 24 is disposed on at least one side of the third narrow border sealant 23, so that when the third narrow border sealant 23 is being cured by irradiation, the light penetration depth is enhanced by the third reflective layer 24 reflecting light. Therefore, the curing depth of the third narrow border sealant 23 is increased and the curing rate of the third narrow border sealant 23 is increased, which facilitates forming the box structure of the touch panel 2 by using the third narrow border sealant 23 with a short width. In this way, the display panel 1, the touch panel 2, and the portion between the display panel 1 and the touch panel 2 all have a narrow border structure. Therefore, a touch display device with a narrow border is realized.

As mentioned above, in the present embodiment, as shown in FIG. 5, the third reflective layers 24 are disposed on both sides of the third narrow border sealant 23. Obviously, the third reflective layers 24 are disposed on both sides of the third narrow border sealant 23, such that the light is reflected multiple times between the upper and lower third reflective layers 24 during the process of curing the third narrow border sealant 23 by lateral irradiation with an ultraviolet light source. In this way, the optical path of the light within the third narrow border sealant 23 is increased, the curing depth of the third narrow border sealant 23 is increased, and the saturation of the light per unit area of the third narrow border sealant 23 is also increased, therefore the curing rate of the third narrow border sealant 23 is increased. The material of the third reflective layer 24 may be the same as the material of the first reflective layer 15 or the same as the material of the second reflective layer 32, and which will not be repeated here.

It should be note that, the existing touch screen is composed of a display panel and a touch panel with a protective cover plate, wherein the protective cover plate is limited by the physical strength, and the thickness of the protective cover plate is greater than 3.0 mm, which is much greater than the thickness of the display panel, such as liquid crystal panels. Except for the protective cover plate, the touch panel also includes a touch substrate, and an optical adhesive layer for adhering the protective cover plate and the touch substrate. Therefore, the thickness difference between the display panel and the touch panel is further increased. When the display panel and the touch panel are adhered by edge lamination in vacuum, the display panel with less thickness is bent toward the touch substrate resulting in deformation. In addition, the touch panel is bent and is limited by the optical adhesive layer disposed between the protective cover plate and the touch substrate. In the present embodiment, the package cover plate 21 is adhered with the touch substrate 22 by the third narrow border sealant 23, such that the touch panel is formed as a box structure similar to the display panel 1, and the problem, that the touch panel is bent and is limited by the optical adhesive layer, is also solved. In addition, it is obvious that the touch panel with less thickness is easier to bend, but the touch panel 2 with a box structure can reduce the thickness of the touch panel 2 and prevent the display panel from deformation caused by the display panel 1 be bent toward the touch substrate 22 during edge lamination in vacuum.

In summary, in the present embodiment, the package cover plate 21 is adhered with the touch substrate 22 by the third narrow border sealant 23 located in the non-display area 20, and the third narrow border sealant 23 is disposed on at least one side of the third narrow border sealant 23. In this way, the touch panel 2 with a narrow border is realized, and the thickness of the touch panel 2 is also reduced by forming the touch panel 2 as a box structure. Therefore, the deformation caused by the display panel 1 be bent toward the touch substrate 22 during edge lamination in vacuum can be avoided.

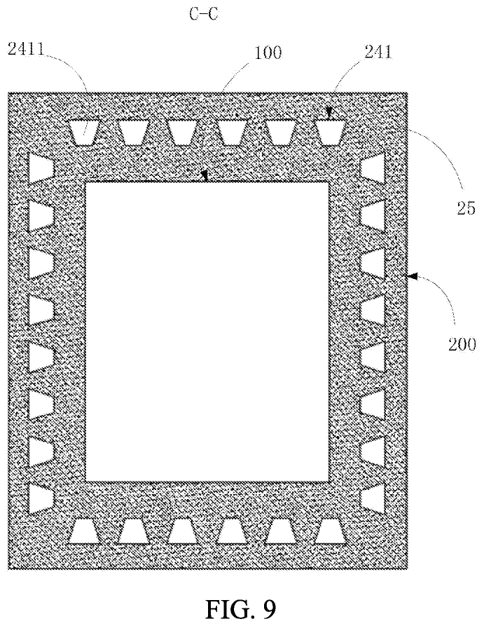

In one embodiment, as shown in FIG. 9 to FIG. 11, the third reflective layer 24 includes a third reflective pattern 241, and an area of a side of the third reflective pattern 241 away from the display area 100 is greater than an area of a side of the third reflective pattern 241 close to the display area 100. It should be understood that the third reflective layer 24 may be patterned to form the third reflective pattern 241, and the effect produced by the third reflective pattern 241 is similar to the first reflective pattern 151 and the second reflective pattern 321. In this way, the area of the side of the third reflective pattern 241 away from the display area 100 is greater than the area of the side of the third reflective pattern 241 close to the display area 100, which results the side of the third reflective pattern 321 away from the display area 100 has a batter light reflecting ability than the side of the third reflective pattern 214 close to the display area 100. That facilitates the light which just entered the third narrow border sealant 23 with a stronger light intensity be reflected in more times. In addition, the side of the third reflective pattern 241 close to the display area 100 has a less reflective area, and a greater hollow position is generated. That facilitates the third narrow border sealant 23 adhering with the package cover plate 21 or the touch substrate 22.

In one embodiment, as shown in FIG. 9 to FIG. 11, the third reflective pattern 241 includes a plurality of third reflectors 2411, and the plurality of third reflectors 2411 are disposed around the display area 100 and arranged as at least one circle; wherein,

when the third reflective pattern 241 includes the plurality of third reflectors 2411 arranged as one circle, an area of a side portion of the third reflector 2411 away from the display area 100 is greater than an area of another side portion of the third reflector 2411 close to the display area 100;

when the third reflective pattern 241 includes the plurality third reflectors 2411 arranged as at least two circles, in the adjacent two circles of the plurality of third reflectors 2411, an area of the third reflector 2411 in the circle away from the display area 100 is greater than an area of the third reflector 2411 in the other circle close to the display area.

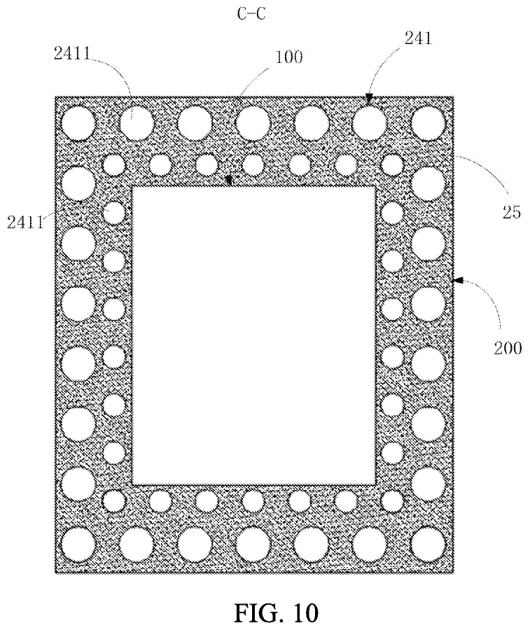

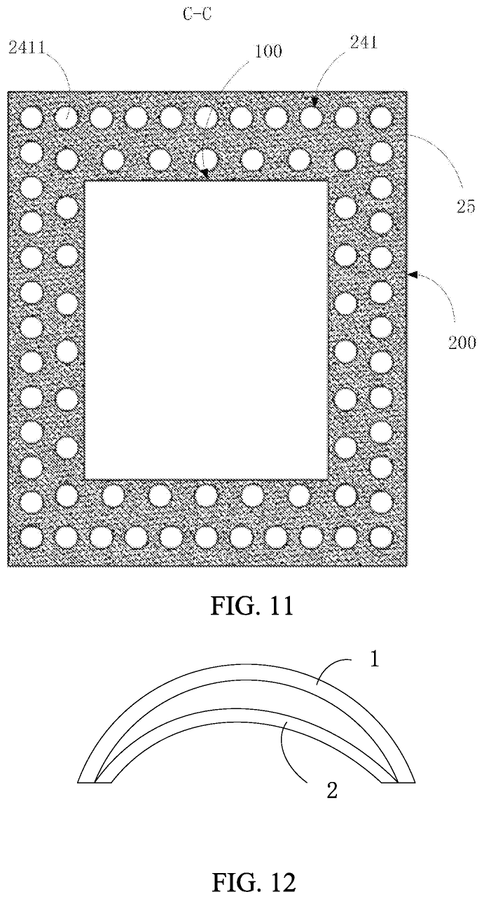

It should be understood that, the third reflector 2411 may have the same shape selection as the first reflector 1511 or the second reflector 3211, and which will not be repeated here. Specifically, as shown in FIG. 9, when the third reflective pattern 241 includes the plurality of third reflectors 2411 arranged as one circle, the third reflector 2411 may be a triangle or a trapezoid, such that the area of a side portion of the third reflector 2411 away from the display area 100 is greater than the area of another side portion of the third reflector 2411 close to the display area 100. For example, when the shape of the third reflector 2411 is a trapezoid, the short side portion of the third reflector 2411 is located in the side close to the display area 100, and the long side portion of the third reflector 2411 is located in the side away from the display area 100, such that the area of a side portion of the third reflector 2411 away from the display area 100 is greater than the area of another side portion of the third reflector 2411 close to the display area 100. As shown in FIG. 10, when the third reflective pattern 241 includes the plurality third reflectors 2411 arranged as at least two circles, in the adjacent two circles of the plurality of third reflector 2411, the area of each the third reflector 2411 in the circle away from the display area 100 is greater than the area of each the third reflector 3211 in the other circle close to the display area 100. As shown in FIG. 11, in the adjacent two circles of the plurality of third reflectors 2411, the area of the third reflector 3211 in the circle away from the display area 100 is greater than the area of the third reflector 2411 in the other circle close to the display area 100 can be realized by ensuring that an arrangement density of the plurality of third reflectors 2411 in the circle away from the display area 100 is greater than an arrangement density of the plurality of third reflectors 2411 in the other circle close to the display area 100.

In one embodiment, as shown in FIG. 5, a second black retaining wall 25 is disposed on a side of the third reflective layer 24 away from the third narrow border sealant 23. It should be understood that, in the touch panel 2, structures such as the second black retaining wall 25 and the like have almost zero reflectance to light, which are very easy to absorb light, so that the light intensity of the light curing the third narrow border sealant 23 is reduced. In the present embodiment, the third reflective layer 24 is disposed between the second black retaining wall 25 and the third narrow border sealant 23, which reduces the absorption of light by the second black retaining wall 25. Specifically, when the third reflective layer 24 is only disposed on one side of the third narrow border sealant 23, the second reflective layer 24 is disposed on the side of the third narrow border sealant 23 close to the second black retaining wall 25.

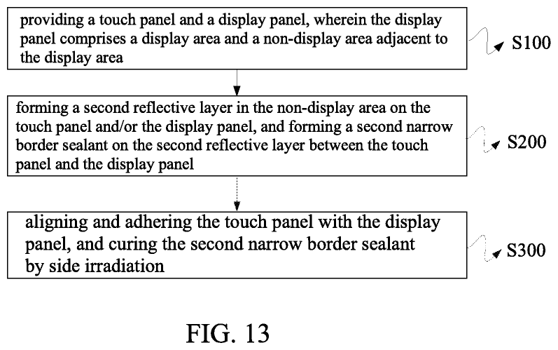

The present disclosure further provides a method for manufacturing a touch display device, as shown in FIG. 13, wherein the method includes the following steps:

Step S100: providing a touch panel 2 and a display panel 1, wherein the display panel 1 comprises a display area 100 and a non-display area 200 adjacent to the display area 100;

Step S200: forming a second reflective layer 32 in the non-display area 200 on the touch panel 2 and/or the display panel 1, and forming a second narrow border sealant 31 on the second reflective layer 32 between the touch panel 2 and the display panel 1; and

Step S300: aligning and adhering the touch panel 2 with the display panel 1, and curing the second narrow border sealant 21 by lateral irradiation.

It should be understood that, the second reflective layer 32 located in the non-display area 200 can be formed on the touch panel 2, or be formed on the display panel 1, or be formed on the display panel 1 and the touch panel 2. Specifically, the second reflective layer 32 can be formed by various methods such as evaporation, or vapor deposition. Specifically, the ultraviolet light source mentioned above can be used in the step of curing the second narrow border sealant 21 by lateral irradiation. The formation of the second reflective layer 32 is preferentially performed, such that second reflective layer 3 facilitates the reflection of the light curing the second narrow border sealant 31. Therefore, the curing depth and curing rate are both increased. Lateral irradiation is a well-developed technology, which will not be repeated here.

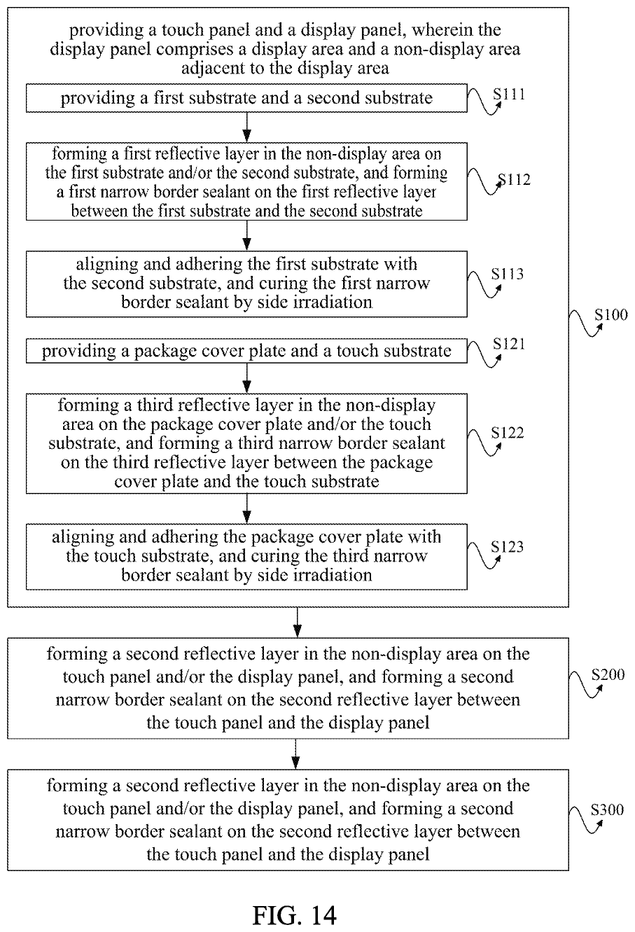

In one embodiment, as shown in FIG. 14, the step of providing the display panel 1 includes:

Step S111: providing a first substrate 11 and a second substrate 12;

Step S112: forming a first reflective layer 15 in the non-display area 200 on the first substrate 11 and/or the second substrate 12, and forming a first narrow border sealant 123 on the first reflective layer 15 between the first substrate 11 and the second substrate 12; and

Step S113: aligning and adhering the first substrate 11 with the second substrate 12, and curing the first narrow border sealant 13 by lateral irradiation.

In one embodiment, as shown in FIG. 14, the step of providing the touch panel 2 includes:

Step S121: providing a package cover plate 21 and a touch substrate 22;

Step S122: forming a third reflective layer 24 in the non-display area 200 on the package cover plate 21 and/or the touch substrate 22, and forming a third narrow border sealant 23 on the third reflective layer 24 between the package cover plate 21 and the touch substrate 22; and

Step S123: aligning and adhering the package cover plate 21 with the touch substrate 22, and curing the third narrow border sealant 23 by lateral irradiation.

Obviously, as mentioned above, the first narrow border sealant 13 is cured by lateral irradiation, and the third narrow border sealant 23 is cured by lateral irradiation. Due to The formation of the first reflective layer 15 and the third reflective layer 24, the curing depth of the first narrow border sealant 13 and the third narrow border sealant 23 are respectively increased, and the curing rate of the first narrow border sealant 13 and the third narrow border sealant 23 are respectively increased. Lateral irradiation is a well-developed technology, which will not be repeated here.

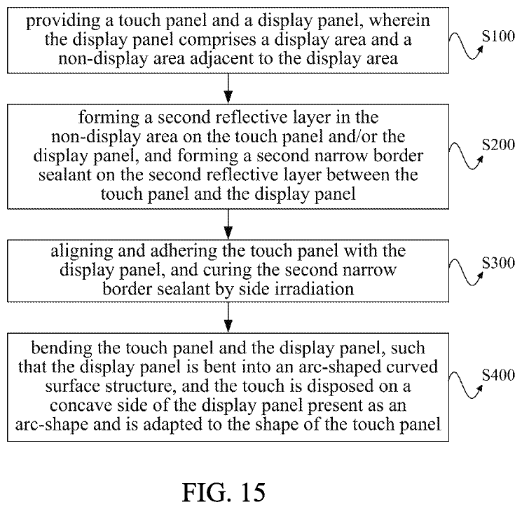

it should be noted that, as shown in FIG. 15, the method for manufacturing a touch display device further includes the following steps:

Step S400: bending the touch panel 2 and the display panel 1, such that the display panel 1 is bent into an arc-shaped curved surface structure, and the touch panel 2 is disposed on a concave side of the display panel 1 present as an arc-shape and is adapted to the shape of the touch panel 2.

It should be understood that, as shown in FIG. 12, after adhering the touch panel 2 and the display panel 1 by edge lamination, the method further includes a bending step. In the bending step, because the touch panel 2 is formed as a box structure, the thickness of the touch panel 2 can be reduced, and the structure, such as the optical adhesive layer, restricted the touch panel be bent is omitted. Therefore, that facilitates bend the touch display device into a curved touch display screen.

In summary, in the present disclosure, the first reflective layer 15 is disposed on at least one side of the first narrow border sealant 13, so that when the first narrow border sealant 13 is being cured by irradiation, the light penetration depth is enhanced by the first reflective layer 15 reflecting light. Therefore, the curing depth of the first narrow border sealant 13 is increased and the curing rate of the first narrow border sealant 13 is increased, which facilitates forming the box structure of the display panel 1 by using a first narrow border sealant 13 with a short width. The box structure, such as a display panel 1, with a narrow border, is realized. In the touch display device of the present disclosure, the touch display device with a narrow border is realized by disposing the second reflective layer 32 on at least one side of the second narrow border sealant 31 located between the display panel 1 and the touch panel 2. In addition, the method for manufacturing this structure is well-developed and simple, and the curing rate of the sealant in the method is efficient, which facilitates manufacturing the touch display device with the narrow border.

In view of the above, although the present invention has been disclosed by way of preferred embodiments, the above preferred embodiments are not intended to limit the present invention, and one of ordinary skill in the art, without departing from the spirit and scope of the invention, the scope of protection of the present invention is defined by the scope of the claims.

What is claimed is:

1. A display panel, comprising a display area and a non-display area adjacent to the display area, the display panel comprising:
a first substrate and a second substrate disposed opposite to each other;
a first narrow border sealant located in the non-display area, and a liquid crystal layer located in the display area disposed between the first substrate and the second substrate; and
a first reflective layer disposed on at least one side of the first narrow border sealant.

2. The display panel according to claim 1, wherein the first reflective layer comprises a first reflective pattern, and an area of a side of the first reflective pattern away from the display area is greater than an area of a side of the first reflective pattern close to the display area.

3. The display panel according to claim 2, wherein the first reflective pattern comprises a plurality of first reflectors, and the plurality of first reflectors are disposed around the display area and arranged as at least one circle; wherein,
when the first reflective pattern comprises the plurality of first reflectors arranged as one circle, an area of a side portion of the first reflector away from the display area is greater than an area of another side portion of the first reflector close to the display area;
when the first reflective pattern comprises the plurality first reflectors arranged as at least two circles, in the adjacent two circles of the plurality of first reflectors, an area of the first reflector in the circle away from the display area is greater than an area of the first reflector in the other circle close to the display area.

4. The display panel according to claim 3, wherein the first reflective pattern comprises the plurality of first reflectors arranged as at least two circles, in the adjacent two circles of the plurality of first reflectors, an arrangement density of the plurality of first reflectors in the circle away from the display area is greater than an arrangement density of the plurality of first reflectors in the other circle close to the display area.

5. The display panel according to claim 1, wherein a first black retaining wall is disposed on a side of the first reflective layer away from the first narrow border sealant.

6. A touch display device, comprising:
a touch panel, and a display panel as claimed in claim 1;
a second narrow border sealant located in the non-display area disposed between the display panel and the touch panel; and
a second reflective layer disposed on at least one side of the second narrow border sealant.

7. The touch display device according to claim 6, wherein the second reflective layer comprises a second reflective pattern, and an area of a side of the second reflective pattern away from the display area is greater than an area of a side of the first reflective pattern close to the display area.

8. The touch display device according to claim 7, wherein the second reflective pattern comprises a plurality of second reflectors, and the plurality of second reflectors are disposed around the display area and arranged as at least one circle; wherein,
when the second reflective pattern comprises the plurality of second reflectors arranged as one circle, an area of a side portion of the second reflector away from the display area is greater than an area of another side portion of the second reflector close to the display area;
when the second reflective pattern comprises the plurality of second reflectors arranged as at least two circles, in the adjacent two circles of the plurality of second reflectors, an area of second reflector in the circle away from the display area is greater than an area of the second reflector in the other circle close to the display area.

9. The touch display device according to claim 8, wherein the second reflective pattern comprises the plurality of second reflectors arranged as at least two circles, in the adjacent two circles of the plurality of second reflectors, an arrangement density of the plurality of second reflectors in the circle away from the display area is greater than an arrangement density of the plurality of second reflectors in the other circle close to the display area.

10. The touch display device according to claim 6, wherein the touch panel comprises:
a package cover plate and a touch substrate disposed opposite to each other;
a third narrow border sealant located in the non-display area disposed between the package cover plate and the touch substrate; and
a third reflective layer disposed on at least one side of the third narrow border sealant.

11. The touch display device according to claim 10, wherein the third reflective layer comprises a third reflective pattern, and an area of a side of the third reflective pattern away from the display area is greater than an area of a side of the third reflective pattern close to the display area.

12. The touch display device according to claim 11, wherein the third reflective pattern comprises a plurality of third reflectors, and the plurality of third reflectors are disposed around the display area and arranged as at least one circle; wherein,
when the third reflective pattern comprises the plurality of third reflectors arranged as one circle, an area of a side portion of the third reflector away from the display area is greater than an area of another side portion of the third reflector close to the display area;
when the third reflective pattern comprises the plurality third reflectors arranged as at least two circles, in the adjacent two circles of the plurality of third reflectors, an area of the third reflector in the circle away from the display area is greater than an area of the third reflector in the other circle close to the display area.

13. The touch display device according to claim 12, wherein the third reflective pattern comprises the plurality of third reflectors arranged as at least two circles, in the adjacent two circles of the plurality of third reflectors, an arrangement density of the plurality of third reflectors in the circle away from the display area is greater than an arrangement density of the plurality of third reflectors in the other circle close to the display area.

14. The touch display device according to claim 10, wherein a second black retaining wall is disposed on a side of the third reflective layer away from the third narrow border sealant.

15. The touch display device according to claim 6, wherein the first reflective layer comprises a first reflective pattern, and an area of a side of the first reflective pattern away from the display area is greater than an area of a side of the first reflective pattern close to the display area.

16. The touch display device according to claim 15, wherein the first reflective pattern comprises a plurality of first reflectors, and the plurality of first reflectors are disposed around the display area and arranged as at least one circle; wherein,
when the first reflective pattern comprises the plurality of first reflectors arranged as one circle, an area of a side portion of the first reflector away from the display area is greater than an area of another side portion of the first reflector close to the display area;
when the first reflective pattern comprises the plurality first reflectors arranged as at least two circles, in the adjacent two circles of the plurality of first reflectors, an area of the first reflector in the circle away from the display area is greater than an area of the first reflector in the other circle close to the display area.

17. The touch display device according to claim 16, wherein the first reflective pattern comprises the plurality of first reflectors arranged as at least two circles, in the adjacent two circles of the plurality of first reflectors, an arrangement density of the plurality of first reflectors in the circle away from the display area is greater than an arrangement density of the plurality of first reflectors in the other circle close to the display area.

18. A method for manufacturing a touch display device, comprising the following steps:
providing a touch panel and a display panel, wherein the display panel comprises a display area and a non-display area adjacent to the display area;
forming a second reflective layer in the non-display area on the touch panel and/or the display panel, and forming a second narrow border sealant on the second reflective layer between the touch panel and the display panel; and
aligning and adhering the touch panel with the display panel, and curing the second narrow border sealant by lateral irradiation.

19. The method for manufacturing a touch display device according to claim 18, wherein the step of providing the display panel comprises:
providing a first substrate and a second substrate;
forming a first reflective layer in the non-display area on the first substrate and/or the second substrate, and forming a first narrow border sealant on the first reflective layer between the first substrate and the second substrate; and
aligning and adhering the first substrate with the second substrate, and curing the first narrow border sealant by lateral irradiation.

20. The method for manufacturing a touch display device according to claim 18, wherein the step of providing the touch panel comprises:
providing a package cover plate and a touch substrate;
forming a third reflective layer in the non-display area on the package cover plate and/or the touch substrate, and forming a third narrow border sealant on the third reflective layer between the package cover plate and the touch substrate; and
aligning and adhering the package cover plate with the touch substrate, and curing the third narrow border sealant by lateral irradiation.
